(19) United States
(12) Patent Application Publication
(10) Pub. No.: US 2019/0003480 A1
(43) Pub. Date: Jan. 3, 2019

(54) Programmable Fan

(71) Applicants: David R. Hall, Provo, UT (US); Casey Webb, Spanish Fork, UT (US); Jerome Miles, Spanish Fork, UT (US); Christopher Jones, Spanish Fork, UT (US)

(72) Inventors: David R. Hall, Provo, UT (US); Casey Webb, Spanish Fork, UT (US); Jerome Miles, Spanish Fork, UT (US); Christopher Jones, Spanish Fork, UT (US)

(21) Appl. No.: 15/918,370

(22) Filed: Mar. 12, 2018

Related U.S. Application Data
(60) Provisional application No. 62/526,634, filed on Jun. 29, 2017.

(51) Int. Cl. F04D 27/00; F04D 25/08; F04D 25/10; F24F 11/00; F24F 11/57; F21V 33/00; H04R 1/02; G08C 17/02

(52) U.S. Cl. CPC F04D 27/00; F04D 25/088; F04D 25/105; F24F 11/0001; F24F 2120/12; F21V 33/0096; H04R 1/028; G08C 17/02; F24F 11/57

(57) ABSTRACT

A fan assembly is disclosed. The fan assembly is comprised of a fan with a motor and a blade as to create an airflow, and an actuator which is adapted to move the fan in vertical and horizontal directions, such that the fan directs airflow below it. The fan further comprises a controller adapted to control the adapter, and a remote control which is adapted to control the controller. The remote control sends signals to direct the controller, and both are adapted such that the movement of the fan can be programmed to a path set by a user and can also be manipulated to a static position set by the user. Preferably, the remote control is a smart device, such as a smart phone.

### CROSS-REFERENCE TO RELATED APPLICATIONS

This application is a continuation of U.S. provisional application No. 62/526,634 filed 29 Jun. 2017. The entire disclosure of which is incorporated herein by reference.

### TECHNICAL FIELD

This invention relates generally to smart home devices and specifically to smart fans.

### BACKGROUND

Many improvements and developments have been made in the field of smart home devices. Fans, in particular, have been used for hundreds of years as a means of cooling a user or room occupant by creating airflow. Through time, fans have become more advanced and smarter. Originally, fans were static—which is to say that they blew in a single direction. Eventually, fans were made to be able to oscillate—or rotate about an axis such that they blew air in various directions, without requiring that a user move the fan. Likewise, overhead fans have been greatly improved. Many overhead and non-overhead fans are now remote controlled.

However, fans, including those used in garages and under working conditions, are limited in their ability to blow air specifically onto a user, because many fans are either set to blow in one direction or to rotate about a single axis or multi axis. Often while someone is working or occupying a room, they may move around, and require cooling as they change locations, and some variations of fans today include heat tracking and movement tracking mechanisms as to follow a user. Other fans rotate about a room in a pattern that is predetermined by the manufacturer and they do not deviate from this path. As such, oscillating fans can be moved around a room by a user to achieve cooling where a user prefers, but this requires that a user interrupt whatever he or she is doing. Even so, current fans may rotate more than desired, and there may or may not be a way for a user to alter the degree that the fan rotates. While some fans permit a user to limit the degree of rotation, and program their preferred settings into the fan so that the fan remembers these preselected settings when turned off and on. Users are wasting energy if a fan is blowing and cooling areas that they do not desire to cool.

Many remote-controlled fans permit a user to adjust the speed of the fan impeller or blade to increase the airflow output of the fan. In addition, remote controlled fans allow a user to turn the fan off or on. Some remote-controlled fans also allow a user to adjust the position on the axis at which the fan blows. Some fans also move in both vertical and horizontal directions.

### SUMMARY

In a first aspect, the disclosure provides a fan assembly. The fan assembly is comprised of a fan with a motor and a blade as to create an airflow, and an actuator which is adapted to move the fan in vertical and horizontal directions, such that the fan directs airflow below it. The fan further comprises a controller adapted to control the adapter, and a remote control which is adapted to control the controller. The remote control sends signals to direct the controller, and both are adapted such that the movement of the fan can be programmed to a path set by a user and can also be manipulated to a static position set by the user.

In a second aspect, the disclosure provides a fan assembly comprised of mounting hardware for mounting the fan assembly to an overhead, preferably a ceiling.

In a third aspect, the disclosure provides a fan assembly comprised of lights, a camera, speakers, a microphone, a focused light such as a laser, heat and movement sensors, a carbon monoxide detector, a smoke detector, a temperature sensor, and a heating unit, such that the overhead fan assembly may provide additional amenities which can be useful or necessary.

In a fourth aspect, the disclosure provides a fan assembly wherein a mechanism is comprised such that the fan may be lowered away from an overhead, or raised to be nearer an overhead where the fan assembly is placed.

Preferably, the remote-control device is a smart device, such as a smart phone, and wherein the smart phone is used to set a path and wherein the set path can be remembered by the smart phone or smart device such that user can create the path only once, but select it at any time after its creation. And wherein a user may select to set the fan at a static or fixed position.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a front view of the fan assembly.

FIG. 1B is a back view of the of the fan assembly moving between points of a programmed path.

FIG. 2A is a first schematic view of the fan assembly moving between points of a programmed path.

FIG. 2B is a second schematic view of the fan assembly moving between points of a programmed path.

FIG. 2C is a third schematic view of the fan assembly moving between points of a programmed path.

FIG. 2D is a fourth schematic view of the fan assembly moving between points of a programmed path.

FIG. 3A is a first schematic view of the fan assembly sensing a room occupant via sensors and following the room occupant.

FIG. 3B is a second schematic view of the fan assembly sensing a room occupant via sensors and following the room occupant.

FIG. 3C is a third schematic view of the fan assembly sensing a room occupant via sensors and following the room occupant.

FIG. 4 is a front view of the fan assembly and mechanism for lowering the fan away from or nearer to the overhead.

FIG. 5 is a schematic view of the fan providing instructions for a package delivery.

FIG. 6 is an exploded view of the fan assembly.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

The programmable fan may include a motor connected to the fan, forward and rear vents surrounding the fan and motor, a channel shaped fan mount to which at least one of the vents is rotatably connected, a motor that rotates the fan, a second motor that rotates the fan mount on an axis perpendicular to the axis about which the fan rotates, an electronics housing that houses power, control and communications electronics (such as various elements similar to those described in the US 2015-0284221 A1 application) and the motor that rotates the fan mount, a male power outlet and a female power outlet for interconnecting the apparatus to other similar or dissimilar devices, and a mounting bracket by which the apparatus may be mounted overhead to a smart track. In various embodiments, the apparatus may include one or more air flow detectors aligned with the fan outside the vents, and may include a rim of LED lights around an edge of the forward vent.

The apparatus may be mounted to a smart track. Additionally, the apparatus may be daisy chained to other similar or dissimilar devices.

One unique feature of the apparatus is the ability to rotate the fan about a complete 360 degrees. This is accomplished by the dual pivoting. Full rotation of the fan while still effectively transmitting power to the motor may be accomplished by such power transmission mechanisms as described in U.S. Pat. No. 9,860,361. Such power transmission mechanisms may be disposed between the fan vents and the fan mount, and between the fan mount and the electronics housing. Complete rotation of the fan may allow for more sensitivity to air flow dynamics of a room in which the fan is positioned. For example, garages are notorious for having poor, little and/or no air flow and/or air circulation. The apparatus may be programmed to engage in a random oscillation pattern that alternatively circulates air from up to down, from down to up, from right to left, and from left to right. Additionally, the air flow sensor detects undesirable air flow and notify a user to open a window or door, or may automatically activate the fan and engage in a pre-programmed oscillation pattern.

The air flow sensor may also be used as a security feature. A user may set an application associated with the apparatus and other system-integrated smart devices to “away.” The air flow sensor may detect an abnormal air flow pattern which may indicate a window has been broken or opened, or a door has been opened. The application may in turn notify the user of the abnormal condition.

A user may communicate with the apparatus via a wireless network, such as that described in U.S. Published Patent Application No. 2015-028422. For example, an app for controlling the apparatus may be installed on a computer and/or smartphone. The app may include protocol for communicating directly and wirelessly with the apparatus, or for communicating indirectly with the apparatus via a cloud-based network and/or server. The control electronics of the apparatus may store instructions and programming for operating the apparatus, the cloud-based server may store the instructions, and/or the computer/smartphone may store the instructions. Additionally or alternatively, the device may communicate over a network such as is described in U.S. Pat. No. 9,628,126. The apparatus may communicate with other devices on the same network as the apparatus, and may include programming to automatically operate when the apparatus is notified that another or a particular device on the same network is operating.

The programming for the apparatus may include pre-set “smart points.” The smart points may be zones and or directions, corresponding to particular points of rotation for the two motors, that are pre-programmed by a user. The user may select the smart point in the app, and the apparatus may automatically direct air flow along the pre-set direction. Operation of the apparatus may also correspond to operation of one or more other devices. For example, a user may program a correlated smart light to turn on at a set time, and the apparatus may include programming to turn on the fan and direct the flow of air towards an area of the room below that light.

The apparatus may further include one or more motion- and/or position-tracking devices. For example, in one embodiment, a motion tracker is positioned on the front vent. The control electronics, server, or computer/smartphone store instructions to point the fan at an area where motion is detected. The apparatus may include various position-tracking devices, such as by using multiple antennas and a multi-path comparison algorithm to determine a position of a smartphone or other RF-emitting device in the room, and to point the fan at that area of the room. This may allow a person to move around in the room and for the fan to follow the person as they move. Other position-tracking elements may include RFID tags.

The programmable fan with motion tracking and lights is unique in its pairing of motion tracking, programmable set points, and lights. The fan is unique in its ability to hand select points in space and create unique blowing patterns which are determined entirely by the user. An app connected to the fan allows a user to designate points in space and create their own patterns of air flow. Preferably, a point every 1.8 degrees is available for selection. This means that no matter the room that the fan is placed in, and regardless of various obstructions, a user can create a specialized pattern for their preferred airflow.

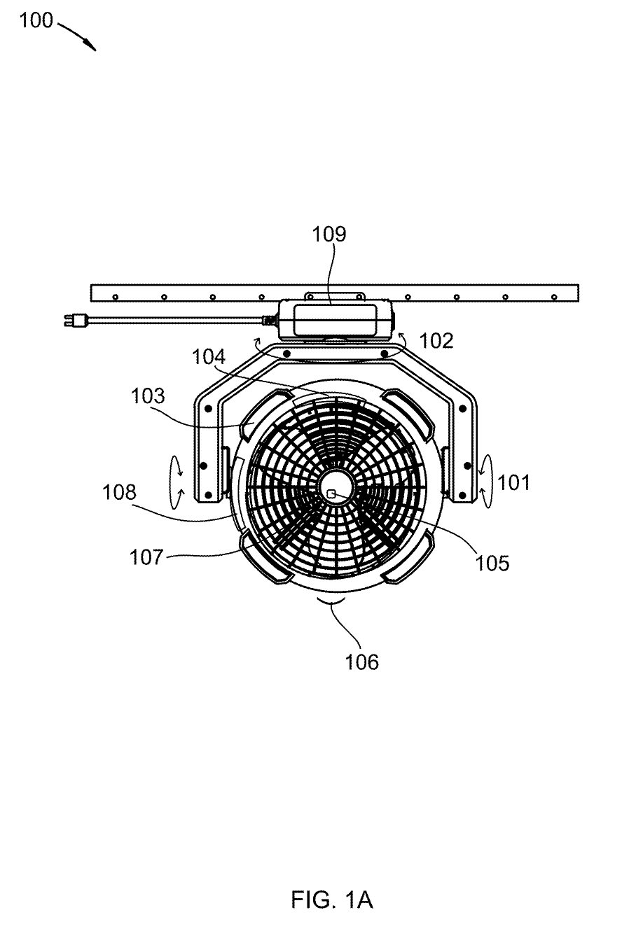

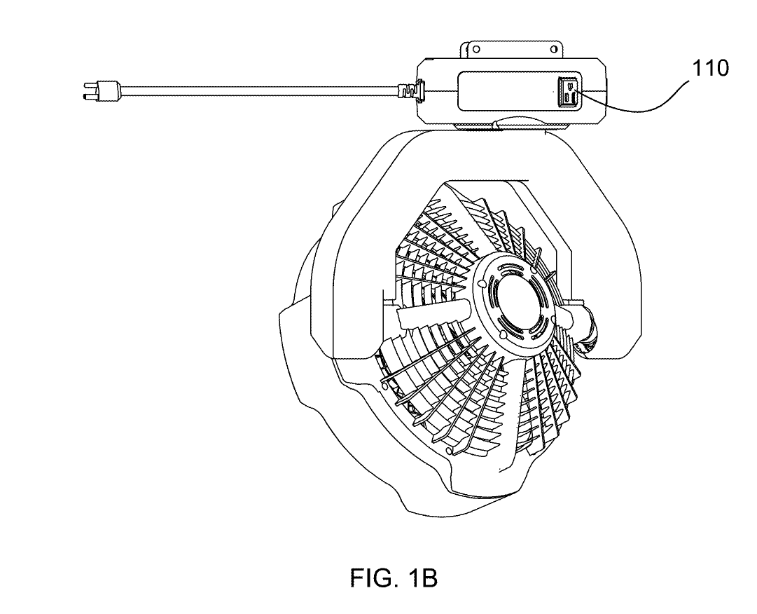

Now referring to FIG. 1, the fan assembly 100 can rotate about an axis 101 vertically, and it can rotate about an axis 102 horizontally. This design allows the fan assembly 100 to direct airflow anywhere beneath the fan assembly 100 when it is attached to an overhead or ceiling. The light 103 is useful in illuminating an area or providing added illumination to allow for improved vision. The light 103 can be a floodlight or colored light, and can be placed at various positions on the fan assembly 100. The light 103 can produce constant lighting, or be a strobe light or flashing light. The light 103 can be positioned on the back of the fan assembly 100, on the side, top, or bottom of the fan assembly 100.

The speakers 104, are useful in playing a variety of recordings. The speakers 104 can play music, or via Bluetooth, a call that a user is receiving via their smart phone. The speakers 104 also work in conjunction with the microphone 108. The microphone 108 can be used to record a message that a user wishes to play via the speakers. In one embodiment, the microphone 108 and the speakers 104 are part of an intercom system. For example, someone in the building wherein the fan assembly 100 is placed may desire to communicate with a user of the fan assembly 100. If an intercom system is installed, someone can use an intercom in a room separate from where the fan assembly 100 is placed, and send an audible message which will play through the speakers 104 of the fan assembly 100. The user of the fan assembly 100 can then respond via the microphone 108. In another embodiment, someone may send an audio message to the user of the fan assembly 100 via their smart phone, which will play via the speakers 104. The user of the fan assembly 100 can then respond to the audio message sent to them via a smart phone by recording their response using the microphone 108. The speakers 104, can also play instructions and deliver warnings. For example, if the carbon monoxide levels become unsafe, a warning message indicating the danger can play over the speakers 104, audibly warning the user of the danger.

The focused light 105 is preferably a laser, and can be directed and pointed at various objects in the room wherein the fan assembly 100 is placed. In one embodiment, the focused light 105 is used to indicate a location where a package should be placed. For example, using a smart security system, such as TrackPIN™, workers of delivery companies can temporarily enter a garage or other confined place. A user of the fan assembly 100 may wish to indicate to the delivery person where to leave the package, such that the package is not left, for example, in the middle of a garage, where a vehicle may need to be parked later on. The focused light 105 can be used to select a point in the garage or area where the fan assembly 100 is placed as directions for where to leave a package. The spotlight 107 is used as intensified lighting.

A camera 106, in this embodiment is attached to the lower side of the fan assembly 100. The camera 106 can be placed on the back, side, or top of the fan assembly 100. The camera 106 can be controlled remotely. Preferably, the camera 106 begins recording whenever an individual enters the place wherein the fan assembly 100 is placed, such as a garage. For example, when a delivery person enters a garage using the TrackPIN′ system, the camera would automatically record the delivery person until they exited the garage. If the package was put in the wrong spot in the garage, or if the delivery person caused damage to the property or the garage or stole anything, a recording is available.

The mounting hardware 109 permits a user to mount the fan assembly 100 to a ceiling, wall, floor, or other surface. Preferably, the fan assembly 100 is mounted to the ceiling or overhead. But the fan assembly 100 can also be mounted to any surface that permits the mounting hardware 109 to attach.

In FIG. 1B, a view of the back of the fan assembly 100 reveals that an electrical outlet 110 allows for the fan assembly 100 to plug directly into an outlet, or for other electrical items to plug into the fan assembly 100. For example, a user may desire additional lighting and can insert another light into the fan via the electrical outlet 110.

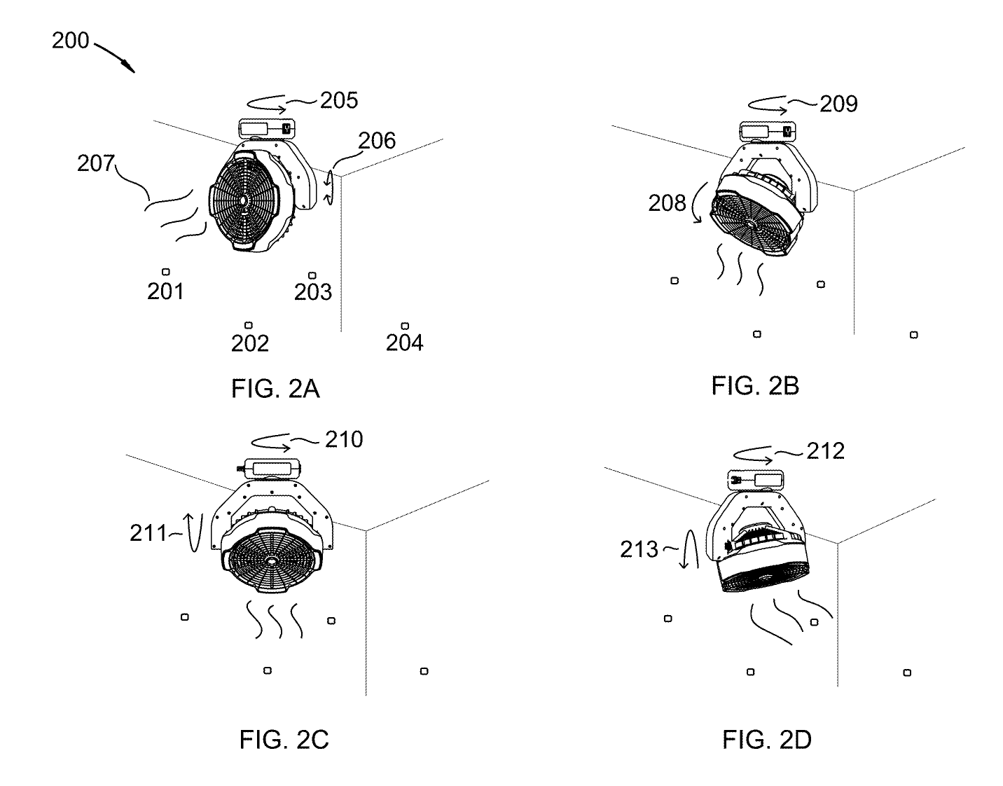

Referring to FIGS. 2A, 2B, 2C, and 2D, an example of a programmed path 200 is set forth. A user can set a specific path for the fan assembly 100 to follow via their remote-controlled device, preferably a smart phone. In FIG. 2A, the fan assembly 100 is blowing air 207 towards the first programmed point 201. The fan assembly 100 made a vertical shift 206 as well as a horizontal shift 205 to hit the point 201. FIG. 2B demonstrates that the fan assembly 100 has moved to hit the second programmed point 202. A second vertical shift downward 208 and another horizontal shift to the left 205 permits the fan assembly 100 to hit point 202. In FIG. 2C, the fan assembly 100 shifts again to reach the third programmed point 204. A vertical shift upward 211 and a third horizontal shift 210 allows the fan to follow the programmed path 200. In FIG. 2D, the fan assembly 100 makes a fourth shift to hit the fourth programmed point 204 by making a vertical shift downward 213 and a fourth horizontal shift to the left 212. The programmed path, once delineated via a remote control, can be stored in the remote control. As such, after a user has entered a programmed path, they need only reselect the already construed path at a future time to engage the fan assembly 100 in following the path. Additionally, in another embodiment, the fan assembly 100 has controls on the fan for delineating a path for the fan assembly 100 to follow. The fan assembly 100 programmed path 200 can be manipulated such that a user determines how much time the fan assembly 100 spends at each point. For example, a user may decide that they want to set the fan assembly 100 to spend 30 seconds at the programmed point 201, 30 seconds at the programmed point 202, 45 seconds at the programmed point 203, and one minute at the programmed point 204. In contrast, a user can program the fan assembly 100 to move constantly through the programmed path 200, never pausing or lingering at a certain point.

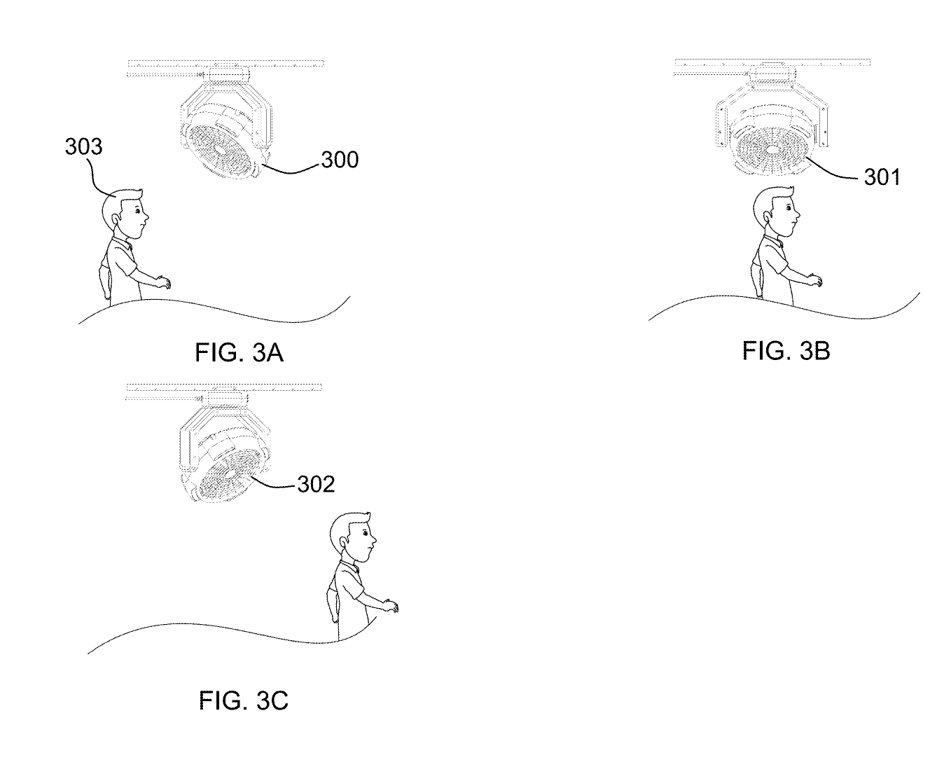

Referring to FIGS. 3A, 3B, and 3C, a user 303 is depicted moving throughout a space. In FIG. 3A, the fan assembly 100 is at position 300. Then, as the user 303 moves across the space, the fan assembly 100 follows, as shown in FIG. 3B, such that the fan assembly 100 is now rotated to position 301. In FIG. 3C, the user 303 has moved across the space yet again, and the fan assembly 100 is still following the user 303 and is in a new position 302. In one embodiment, the fan assembly 100 tracks the user via a heat sensor. Thus, as the heat sensor senses the user, it directs the airflow to the user by rotating on the vertical axis 101 and the horizontal axis 102 as necessary. In another embodiment, the fan assembly 100 includes a movement sensor. Thus, the fan assembly 100 follows a user's movements, and directs airflow at the moving object.

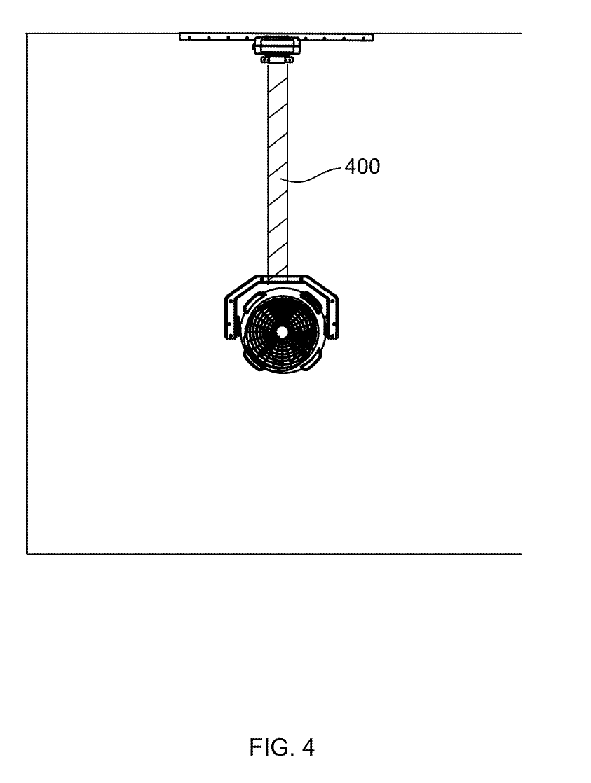

In FIG. 4, a mechanism 400 allows the fan assembly 100 to be lowered away from the overhead. Preferably, the mechanism 400 is a collapsible pole. In another embodiment, the mechanism 400 is an adjustable pole, consisting of various holes and a button, such that a user can manually lower the fan assembly 100 and release the button into the hole corresponding to their preferred level of lowering. Typically, the mechanism 400 is remote controlled, and preferably the remote-control device is a smart phone.

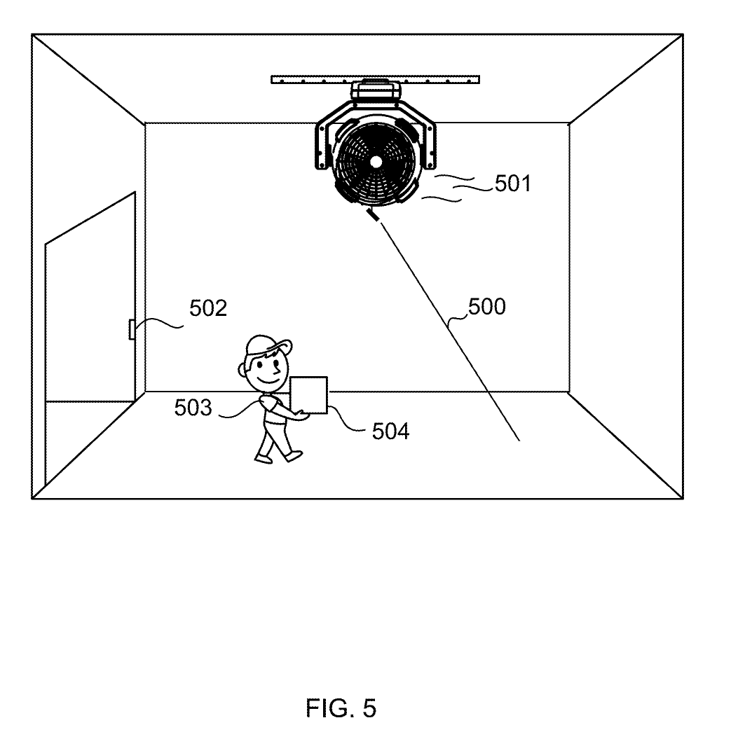

FIG. 5 depicts a delivery person 503, such as a worker from UPS, FedEx, or DHL, entering a place where an fan assembly 100 is placed such as a garage (via a garage opener 502), and delivering a package 504. A laser, 500, indicates where in the garage the package should be left, while audible instructions 501 are played via the speakers 104. Preferably, the camera 106 records the delivery person 503 from the time they enter the garage until they leave.

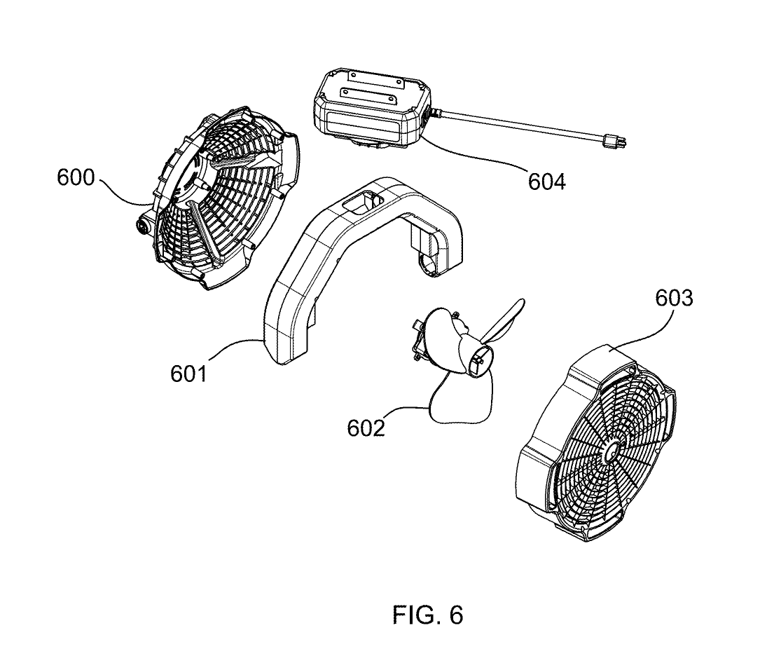

FIG. 6 is an exploded view of the fan assembly 100. Typically, the fan assembly 100 is round. The back of the fan 600 can be built from metal, plastic, etc., and is typically the same material used for the front of the fan 603. An impeller 602, preferably has three blades. In another embodiment, the impeller 602 has as few as one blade. The base 604 of the fan assembly 100 preferably contains an actuator.

All patents and published patent applications referred to herein are incorporated herein by reference. The invention has been described with reference to various specific and preferred embodiments and techniques. Nevertheless, it understood that many variations and modifications may be made while remaining within the spirit and scope of the invention.

What is claimed is:

1. A fan assembly comprising:
a fan with a motor for turning a fan blade and creating airflow;
an actuator adapted to move the fan in both vertical and horizontal directions so as to direct the airflow at various points below the fan;
a controller adapted to control the movement of the actuator; and
wherein the controller can be controlled by a remote-control device which sends signals to direct the controller, and wherein the remote-control device and controller are adapted so that the movement of the fan can be programmed to path set by a user and can also be manipulated to a static position set by the user.

2. The invention of claim 1, further comprising mounting hardware for mounting the fan assembly on a ceiling.

3. The invention of claim 1 wherein the remote-control device is a smart device running an app.

4. The invention of claim 3 wherein the remote-control device is a smart phone.

5. The invention of claim 1 further comprising at least one light.

6. The invention of claim 5 wherein at least one light is a spotlight.

7. The invention of claim 5, wherein at least one light is a broad beam light.

8. The invention of claim 1, further comprising a laser for indicating a location below the fan, such that when a user is receiving a package, a delivery person knows where to place the package, and wherein the laser is controlled by the remote-control device.

9. The invention of claim 1, further comprising speakers.

10. The invention of claim 1, further comprising a microphone.

11. The invention of claim 1, further comprising a temperature sensor for determining the temperature of the space wherein it is placed and wherein the controller is adapted to adjust the strength of the fan's airflow based on input from the temperature sensor.

12. The invention of claim 1, further comprising a movement sensor for tracking and following a user's movement.

13. The invention of claim 12, wherein the movement sensor is a heat sensor, a motion sensor, a camera or a combination thereof.

14. The invention of claim 1, further comprising a heating unit.

15. The invention of claim 1, further comprising a camera.

16. The invention of claim 1, further comprising a mechanism to lower the fan assembly away from the overhead or to raise the fan assembly nearer to the overhead.

17. The invention of claim 1, wherein the fan assembly includes a carbon monoxide sensor, and wherein the controller is adapted to send a warning signal to the remote-control device.

18. The invention of claim 1, wherein the fan assembly provides a node for a WiFi network.

19. The invention of claim 1, wherein the programmed path is remembered and stored by the app running on a smart device.

20. The invention of claim 9, wherein the speakers play instructions and warnings, such that a person making a delivery is instructed audibly on where to leave a package.
